(19) United States
(12) Patent Application Publication
(10) Pub. No.: US 2004/0051899 A1
(43) Pub. Date: Mar. 18, 2004

(54) Image processing device and automatic printing restriction and control method and document reception control method

(75) Inventors: Kazutaka Saitoh, Iwatsuki-shi (JP); Yoshihiro Maei, Iwatsuki-shi (JP); Yoshihiro Sagiya, Iwatsuki-shi (JP); Hideki Fujii, Iwatsuki-shi (JP); Hirotaka Kawabata, Iwatsuki-shi (JP)

Correspondence Address: OLIFF & BERRIDGE, PLC, P.O. BOX 19928, ALEXANDRIA, VA, 22320, US

(73) Assignee: Fuji Xerox Co., Ltd., Tokyo (JP)

(21) Appl. No.: 10/644,926

(22) Filed: Aug. 21, 2003

(30) Foreign Application Priority Data
Sep. 18, 2002 (JP) 2002-271658

(51) Int. Cl. H04N 1/32; G06F 3/12; G06F 11/30; G06F 15/00

(52) U.S. Cl. 358/1.14; 358/1.15; 358/468

(57) ABSTRACT

An automatic printing restriction and control method for an image processing device that comprises a facsimile communication unit capable of handling plural communication methods including facsimile communications via Internet, and prints out documents received by the facsimile communication unit, comprising: presetting whether or not automatic printing of received documents is to be implemented, separately with respect to each of the plural communication methods; and restricting and controlling implementation of automatic printing of received documents in accordance with the settings.

### BACKGROUND OF THE INVENTION

1. Field of the Invention

The present invention relates to an image processing device provided with a communication unit which performs facsimile communication via the Internet, which prints out documents received by the communication unit, and more particularly, to an image processing device, and an automatic printing restriction and control method and a document reception control method for same, wherein output of an unwanted received documents can be prevented, by controlling whether or not a received document is automatically printed out in accordance with desired conditions.

2. Description of the Related Art

In recent years, the use of facsimile devices for performing facsimile communications via the Internet has become widespread, as rapid progress has been made form telephony networks to IP networks.

This refers, more specifically, to Internet Fax corresponding to the ITU-T T.37 standard, which is the basis of electronic mail technology, and Realtime type FoIP (Fax Over IP) corresponding to the ITU-T T.38 standard.

In an Internet facsimile device of this kind, the major benefit for the user is that the sender's communication expenses are reduced to a low cost (or to zero), since the device is able to connect directly to the IP network, and this has a merit in that the sender can transmit facsimiles without worrying about the cost, compared to conventional facsimile (FAX) communications.

However, on the receiver side, printing costs are incurred, and therefore a situation arises where it is desirable to avoid as far as possible the printing out of unwanted documents arising due to the absence of a cost burden on the sender's side.

In cases where this situation is handled by a human operator who judges whether or not to print out the document after confirming the contents of the document, a large burden is placed on the operator in having to make this judgement for all of the received documents, and this is particularly difficult in an environment, such as a business, where a large number of documents are received.

Moreover, in methods for deciding document disposal by means of human checking in this way, there is a risk that the advantage of facsimiles, in that they transmit information comparatively in real time, will be lost.

Furthermore, in the prior art, methods are known wherein the contents of a received document are displayed, and the contents thereof are checked, without it being printed out, in such a manner that it can be stored and subsequently resent (see, for example, Japanese Patent Application Laid-open No. 7-322024).

In a conventional facsimile device capable of Internet facsimile communications as described above, there is a disadvantage in that if unwanted received documents are automatically printed out on the receiver's side, then printing costs are incurred.

Moreover, in a method for resolving this issue wherein a human operator checks the contents and then decides whether or not to perform printing, there a large burden on the operator in making this decision for all of the received documents, and in particular, in environments where the number of received documents is high, this is extremely problematic, in addition to which, there is a risk that print-outs will lose the merit of facsimiles in that they transmit information comparatively in real time.

Therefore, the present invention was devised with the foregoing in view, an object thereof being to provide an image processing device, an automatic printing restricting and controlling method, and a document reception control method, wherein output of unwanted received documents can be prevented by controlling whether or not received documents are printed out automatically, according to desired conditions.

### SUMMARY OF THE INVENTION

An aspect of the invention is an automatic printing restriction and control method for an image processing device that comprises a facsimile communication unit capable of handling plural communication methods including facsimile communications via Internet, and prints out documents received by the facsimile communication unit, comprising: presetting whether or not automatic printing of received documents is to be implemented, separately with respect to each of the plural communication methods; and restricting and controlling implementation of automatic printing of received documents in accordance with the settings.

Another aspect of the invention is an automatic printing restriction and control method for an image processing device which comprises a communication unit for performing facsimile communications via Internet, and prints out documents received by the communication unit, comprising: presetting prescribed condition information for determining whether or not a received document is subject to permission for automatic printing; and implementing automatic printing of a document received in a communication when the contents of transmission identification information transmitted by the sender are checked on the basis of the established prescribed condition information and it is determined that the document received in the communication is subject to permission for automatic printing.

Yet another aspect of the invention is an image processing device that comprises a facsimile communication unit capable of handling plural communication methods including facsimile communications via Internet, and prints out documents received by the facsimile communication unit, comprising: a setting unit for setting whether or not automatic printing of received documents is to be implemented, separately with respect to each of the plural communication methods; and an automatic printing restriction and control unit for restricting and controlling execution of automatic printing of received documents in accordance with the settings of the setting unit.

According to the present invention, since automatic printing of received documents is restricted separately for each of plural communication methods, or the contents of the transmission identification information transmitted by the sender are checked and automatic printing is restricted is previously specified prescribed conditions are satisfied, then it is possible to prevent output of unwanted received documents and hence printing costs can be suppressed.

Moreover, since the contents of the transmission identification information transmitted by the sender are checked and document reception is prohibited in the case of a communication which does not satisfy previously specified prescribed conditions, then the actual reception of facsimile communications from unapproved parties can be restricted.

### BRIEF DESCRIPTION OF THE DRAWINGS

Preferred embodiments of the present invention will be described in detail based on the following figures, wherein:

FIG. 1 is a block diagram showing the system composition of a composite device comprising a facsimile transmission function in which an image processing device relating to the present invention is applied;

FIG. 2 is a flowchart showing the procedure of processing operations in a case where automatic printing of a received document is restricted, separately, for each of plural communication methods;

FIG. 3 shows one example of the composition of a “received document automatic print-out setting screen—classify by communication method”;

FIG. 4 is a flowchart showing the procedure of processing operations for Internet Fax, in a case where the contents of transmission identification information transmitted by the sender are checked and automatic printing is restricted according to whether or not previously specified prescribed conditions are satisfied;

FIG. 5 illustrates a method for extracting transmission identification information;

FIG. 6 shows one example of the composition of a “received document automatic print-out permission check setting screen”;

FIG. 7 illustrates one example of the composition of a check list;

FIG. 8 is a flowchart showing the procedure of processing operations in a case where the processing operations illustrated in FIG. 2 and the processing operations illustrated in FIG. 4 are performed in combination;

FIG. 9 shows a modification example of the processing procedure shown in FIG. 2;

FIG. 10 shows a modification example of the processing procedure shown in FIG. 4;

FIG. 11 shows a modification example of the processing procedure shown in FIG. 8;

FIG. 12 is a flowchart showing the procedure of processing operations for Internet Fax, in a case where the contents of transmission identification information transmitted by the sender are checked and reception of a document in the Internet Fax communication in question is restricted according to whether or not previously specified prescribed conditions are satisfied;

FIG. 13 illustrates one example of the composition of a reception restriction check setting screen;

FIG. 14 shows sequential processing for rejecting a connection request from a sender device; and

FIG. 15 shows a modification example of the processing procedure shown in FIG. 12.

### DESCRIPTION OF THE PREFERRED EMBODIMENTS

Below, embodiments of the present invention are described in detail with reference to the accompanying drawings.

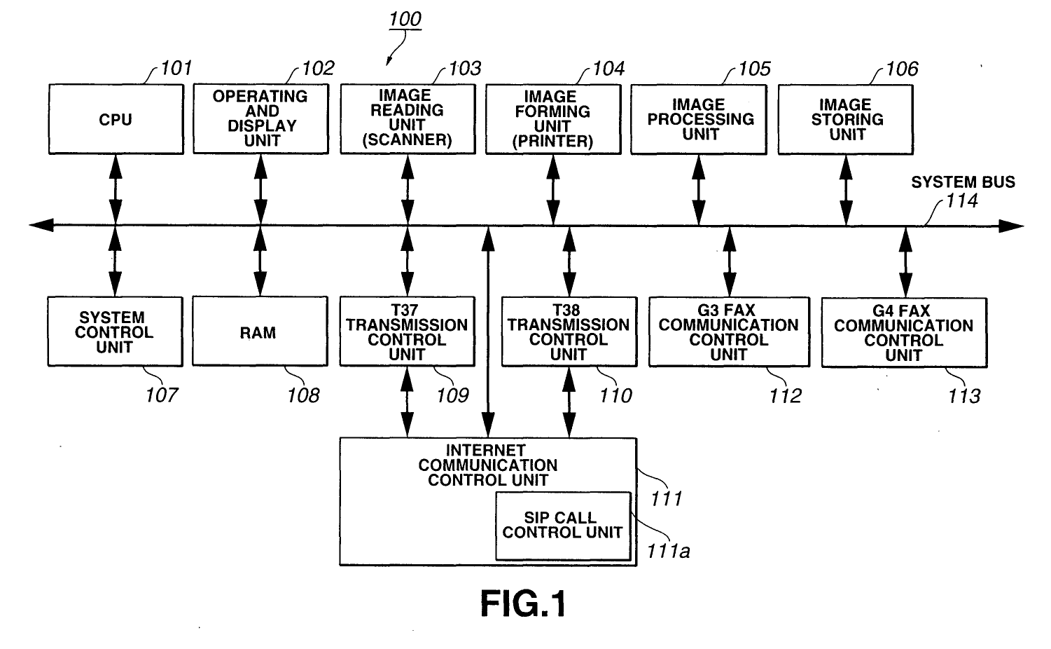

FIG. 1 is a block diagram showing the system composition of a composite device 100 comprising a facsimile transmission function in which an image processing device relating to the present invention is applied.

As shown in FIG. 1, this composite device 100 comprises: a main control unit (CPU) 101, an operating unit 102, an image reading unit (scanner) 103, an image forming unit (printer) 104, an image processing unit 105, an image storing unit 106, a system control unit 107, a RAM 108, a T37 transmission control unit 109, a T38 transmission control unit 110, an Internet communication control unit 111, a G3 transmission control unit 112, and a G4 transmission control unit 113, all of these elements being connected to a system bus 114.

Here, the main control unit (CPU) 101 performs a variety of calculation processes in the composite device 100.

The operating and display unit 102 comprises an operating unit and a display unit whereby the user can make various settings in the composite device 100. For example, in the present embodiment, the respective setting screens described below are displayed, and various settings are instructed by the user according to the setting screen. Moreover, they are also used when registering the check list data described hereinafter.

The image reading unit 103 is a scanner which reads in and inputs an original, or the like, set in position by the user.

The image forming unit 104 is a printer for performing printing onto printing paper, or the like, on the basis of image data input by the aforementioned image reading unit 103, or image data received by facsimile communications, by means of the T37 transmission control unit 109, T38 transmission control unit 110, G3 FAX communication control unit 112, G4 FAX communication control unit 113, or the like, as described hereinafter.

The image processing unit 105 performs various types of image processing of the input image data.

The image storing unit 106 stores image data input by the aforementioned image reading unit 103, or image data received by facsimile communications, by means of the T37 transmission control unit 109, T38 transmission control unit 110, G3 FAX communication control unit 112, G4 FAX communication control unit 113, or the like, as described hereinafter.

The system control unit 107 performs overall control of the composite device 100.

The RAM 108 stores system data and various information for controlling the operations of the composite device 100. In the present embodiment, it stores setting information set on the various setting screens described hereinafter, and check list data, and the like.

The T37 transmission control unit 109 controls Store & Forward type communication protocols in accordance with the procedure in ITU-T (the Telecommunication Standardization Sector of the International Telecommunication Union) Recommendation T-37.

The T38 transmission control unit 110 controls Real type communication protocols in accordance with the procedure in ITU-T Recommendation T-38.

The Internet communication control unit 111 controls the exchange of various data via the Internet, by means of the aforementioned T37 transmission control unit 109 and the aforementioned T38 transmission control unit 110. The Internet communication control unit 111 comprises a SIP (Session Initiation Protocol) call control unit 111a. This SIP (Session Initiation Protocol) call control unit 111a establishes, maintains and terminates calls based on Realtime type Internet FAX T38, by using the procedures stipulated in RFC3261(SIP) and RFC2327(SDP) of the IETF (Internet Engineering Task Force).

The G3 transmission control unit 112 controls communication protocols conforming to G3 facsimile communication procedures.

The G4 transmission control unit 113 controls communication protocols conforming to G4 facsimile communication procedures.

The system bus 114 is connected to the respective constituent elements 101-113 described above, and performs transfer of various data, such as control signals, image data, and the like.

Next, the processing operations ((1)-(5)) of the present invention using the composition described above shall be described.

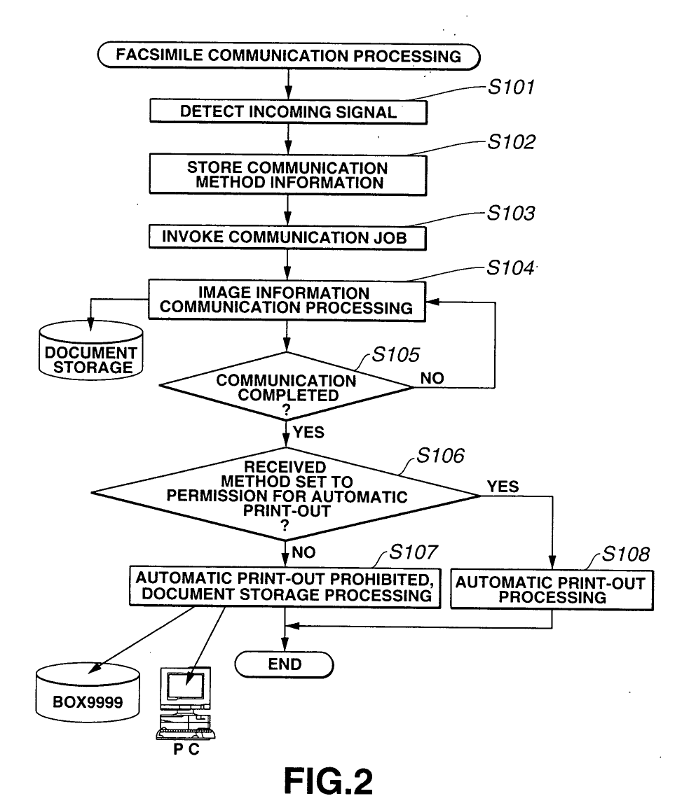

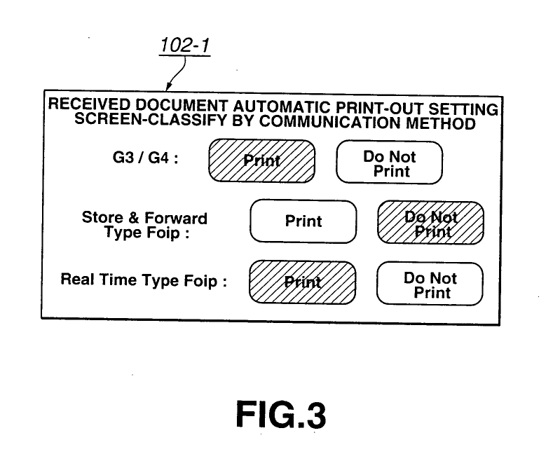

(1) Firstly, the procedure of the processing operations will be described with reference to FIG. 2 and FIG. 3, in relation to a case where automatic printing of received documents is restricted (permitted or prohibited) for each one of plural communication methods (G3/G4 facsimile communications, Store & Forward type communications conforming to ITU-T Recommendation T-37 procedures, Real type communications conforming to ITU-T Recommendation T-38 procedures).

In FIG. 2, if the Internet communication control unit 111, or the existing G3 FAX communication control unit 112, or G4 FAX communication control unit 113 detects an incoming signal on the basis of the control performed by the system control unit 107 (step S101), then firstly, information relating to the communication method detected in the received signal is stored in the RAM 108 (step 102).

Thereupon, a communication job is invoked (step S103), and image information communication processing corresponding to respective communication methods is performed (step S104). In this process, the received document is stored in the image storing unit 106.

Thereupon, when the aforementioned image information communication processing has completed (YES at step S105), it is then determined whether or not the communication method in question is set to permit automatic print-out (step S106). More specifically, the values set by the user via the “Automatic received document print-out setting screen—Classify by communication method” 102-1 illustrated in FIG. 3 are referenced, and it is checked whether or not that communication method is one for which permission for automatic printing has been set. In the example shown in FIG. 3, the user has made settings whereby automatic printing is to be implemented in the case of G3/G4 communications, automatic printing is not to be implemented in the case of Store & Forward FoIP communications, and automatic printing is to be implemented in the case of Real Time FoIP communications. The setting information established via the settings screen 102-1 is stored in the RAM 108 as system data.

Here, if the communication method used in the communication in question has not been set to permit automatic print-out (NO at step S106), then automatic printing of any document received via that communication is prohibited and processing for storing the document is implemented (step S107). In document storage processing, the document is stored in a desired BOX (for example, BOX9999), or transferred to a desired device (personal computer (PC) or the like), and after transfer, the received document stored in the image storing unit 106 is then erased. This storage format can be changed as desired by the used.

After completing storage processing for the document, the composite device 100 completes facsimile communication processing for received jobs.

On the other hand, if, as a result of the judgement in step S106 described above, it is determined that the communication method used for the communication in question has been set to permit automatic print-out (YES at step S106), then automatic printing of the document received in that communication is implemented (step S108). In other words, in the example in FIG. 3 described above, automatic printing is implemented in the case of G3 and G4 facsimile communications, and in the case of Real Time type FoIP communications based on the T-38 procedure.

After completing automatic print-out processing, the composite device 100 completes facsimile communication processing for received jobs.

By means of processing of this kind, since it is possible to restrict automatic printing of received documents separately for plural communication methods (G3/G4 facsimile communications, Store & Forward type communications conforming to ITU-T Recommendation T-37 procedures, Real type communications conforming to ITU-T Recommendation T-38 procedures), then output of unwanted received documents can be prevented.

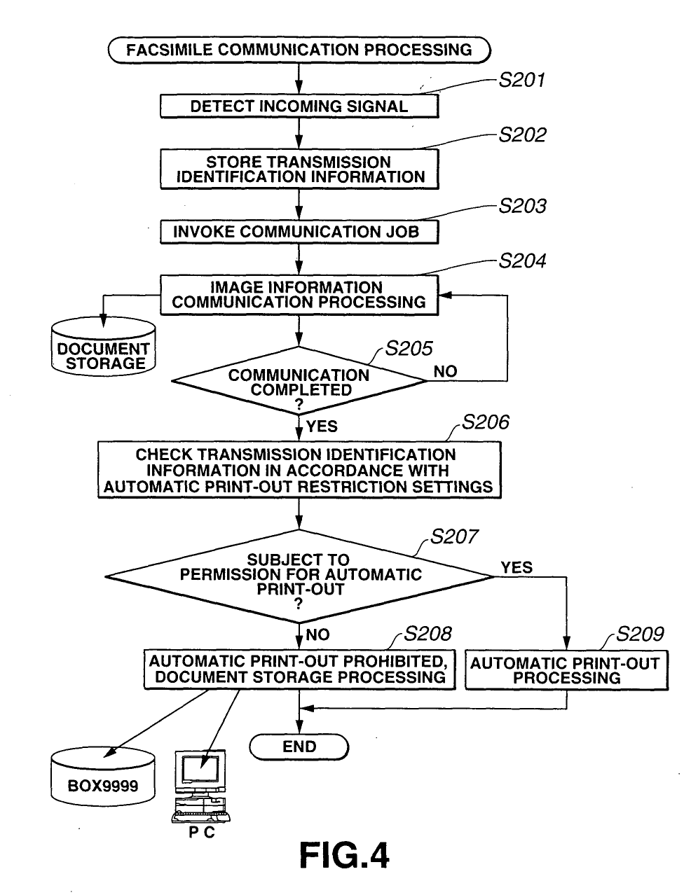

More specifically, for example, since it is possible to make selective settings in such a manner that automatic printing is not implemented for documents received by Internet Fax communications which incur a cheap (or zero) communication expense, then output of unwanted received documents can be prevented and hence printing costs can be restricted. (2) Next, the procedure of processing operations for Internet Fax will be described with reference to FIG. 4 to FIG. 7, with regard to a case where automatic print-out of documents received via Internet Fax communications is restricted by checking the contents of the transmission identification information reported by the sender, and determining whether or not this transmission identification information contains information matching prescribed condition information established previously.

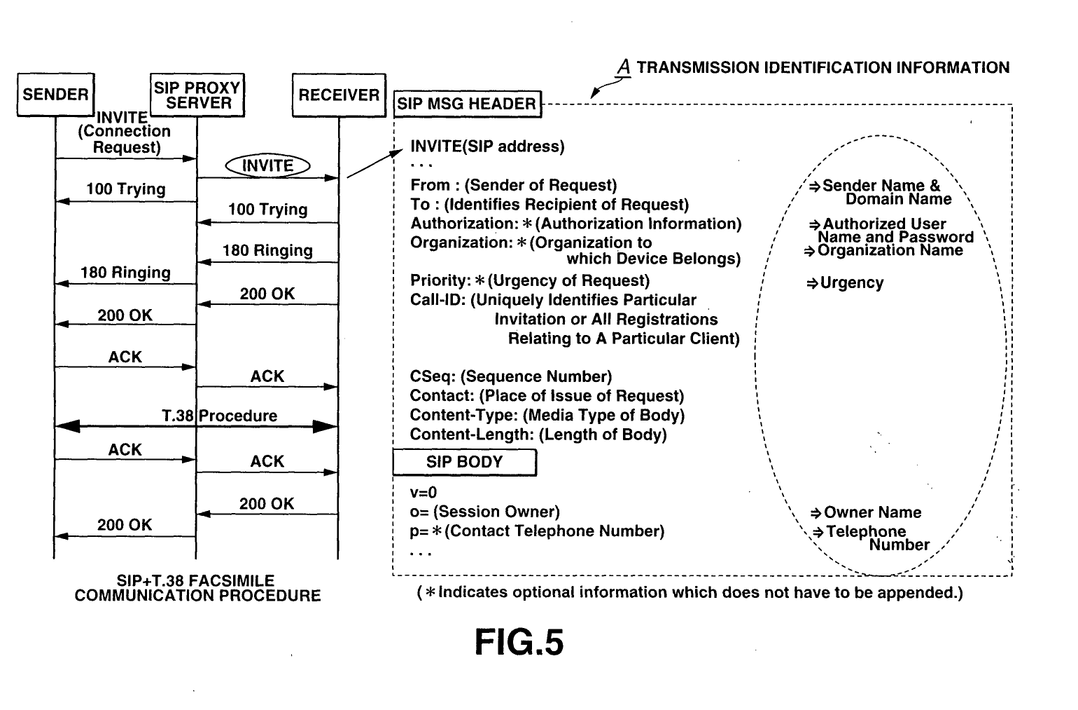

In FIG. 4, if the Internet communication control unit 111 detects an incoming signal on the basis of the control implemented by the system control unit 107 (YES at step S201), then firstly, the transmission identification information is stored in the RAM 108 (step S202). Here, FIG. 5 shows the method for extracting the transmission identification information. The left-hand side of FIG. 5 shows one compositional example of a sequence in SIP+T.38 facsimile communications, and the right-hand side of FIG. 5 shows one compositional example of an SIP MSG Header and SIP Body of transmission identification information transmitter by the sender. In this way, according to the present embodiment, in Internet Fax communications, the required transmission identification information, in particular, the portion enclosed by the dotted oval line, is extracted from the SIP MSG Header and SIP Body during the INVITE (connection request) from the sender device.

Thereupon, a communication job is invoked (step S203), and image information communication processing corresponding the communication method is performed (step S204). In this process, the received document is stored in the image storing unit 106.

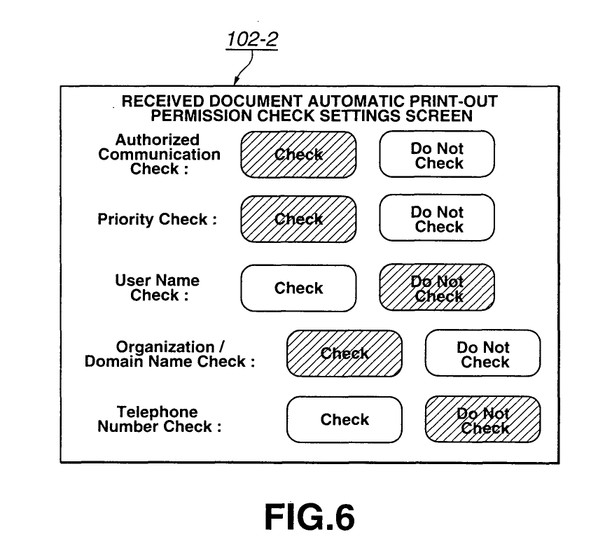

Thereupon, when the aforementioned image information communication processing has completed (YES at step S205), the transmission identification information is checked in accordance with the automatic print-out restriction settings (step S206). More specifically, the transmission identification information is checked on the basis of the values set by the user via the “Received document automatic print-out setting screen” 102-2 illustrated in FIG. 6, and it is judged whether or not the received document is one for which the user has permitted automatic printing.

In other words, if the user has set the authorized communication check option to “check”, then on the settings screen 102-2 shown in FIG. 6, the “Authorization” (authorization information) contained in the transmission identification information stored in the RAM 108 is referenced and it is decided to carry out automatic printing, if the User name and Password transmitted by the sender using a digest authorization mechanism are authorized by the receiving device.

Moreover, in FIG. 6, if the user has set the priority check option to “check”, then the Priority (the urgency of the Request) contained in the transmission identification information stored in the RAM 108 is referenced and it is decided to carry out automatic printing is the priority of the communication is high. In other words, judgement is made on the basis of the Priority, and if the Priority is set to “urgent” or “emergency”, then the priority is judged to be high, whereas if it is set to “non-urgent” or “normal”, then the priority is judged to be low.

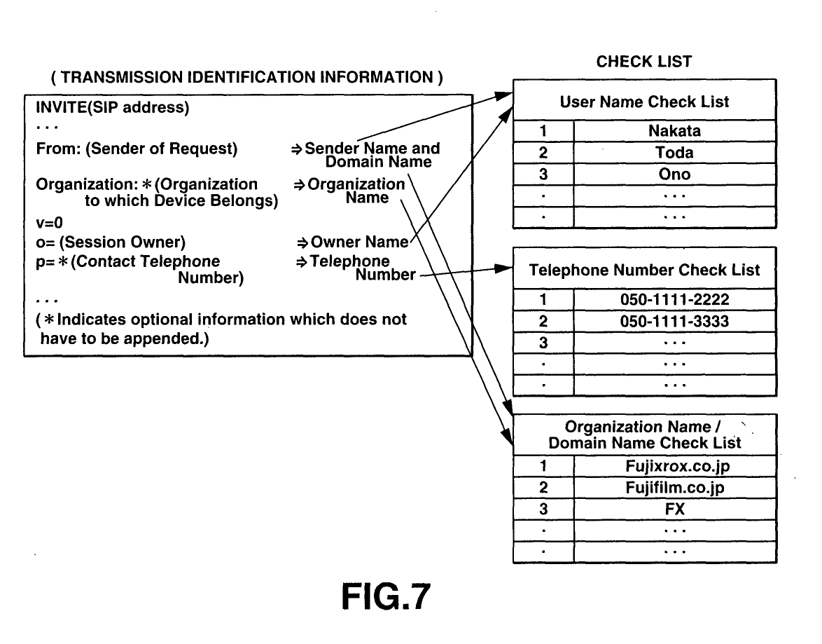

Moreover, in FIG. 6, if the user has set the User name check option to “check”, then in addition to referencing the From information (the transmitter of the request) contained in the transmission identification information stored in the RAM 108, the registration information (see FIG. 7) registered in a previously established and stored User name check list is also referenced, and it is decided to carry out automatic printing if the user name matches a user name registered in the check list.

Moreover, in FIG. 6, if the user has set the organization/domain name check option to “check”, then in addition to referencing the Organization information (name of organization to which device belongs) and the From information (the transmitter of the request) contained in the transmission identification information stored in the RAM 108, the information registered in a previously established and stored organization name/domain name check list (see FIG. 7) is also referenced, and it is decided to carry out automatic printing if the organization name/domain name matches one registered in the check list.

Moreover, in FIG. 6, if the user has set the telephone number check option to “check”, then in addition to referencing the p=contact telephone number (telephone number) contained in the transmission identification information stored in the RAM 108, the registration information (see FIG. 7) registered in a previously established and stored telephone number check list is also referenced, and it is decided to carry out automatic printing if the telephone number matches one registered in the check list.

If, as a result of the check judgement performed in step S206 described above, it is determined that the document received in the communication in question is not one subject to permission for automatic printing (NO at step S207), then the automatic printing of the received document is prohibited and processing for storing the document is implemented (step S208).

On the other hand, if, as a result of the check performed in step S206 described above, it is determined that the document received in the communication in question is one which is subject to permission for automatic printing (YES at step S207), then automatic printing of this received document is implemented (step S209). In other words, in the example in FIG. 6, if the communication in question is an authorized communication, or if it is a communication of high priority, or if the organization name/domain name is one that is registered in the check list, or if the telephone number is one that is registered in a check list, then automatic printing is implemented.

In the processing flowchart in FIG. 4 described above, a composition was described wherein a check list registering identification information for permitting automatic print-out of received documents is maintained, and the received transmission identification information is compared with the data in the aforementioned check list, automatic printing of the received document being implemented if the aforementioned information and data are matching, but the present embodiment is not limited to this, and it is also possible to adopt a composition wherein a check list registering identification information for which automatic print-out of received documents is prohibited, the received transmission identification information being compared with the data in this check list, and automatic print-out of the received document not being performed if the aforementioned information and data are matching.

By implementing processing of this kind, in Internet Fax communications, automatic print-out of documents received via Internet Fax communications can be restricted by checking the contents of the transmission identification information reported by the sender, and determining whether or not this transmission identification information contains information matching prescribed condition information established previously, and hence output of unwanted received documents can be prevented.

More specifically, for example, automatic printing is only implemented in the case of documents which satisfy previously established conditions (parties approved by the user), in such a manner that automatic printing of documents received by Internet Fax communications having a cheap (or zero) communication expense is restricted. Thereby, since documents from unapproved parties are not printed out unnecessarily, printing costs can be suppressed.

Moreover, the task of confirming the contents of received documents, as in the prior art, can be eliminated.

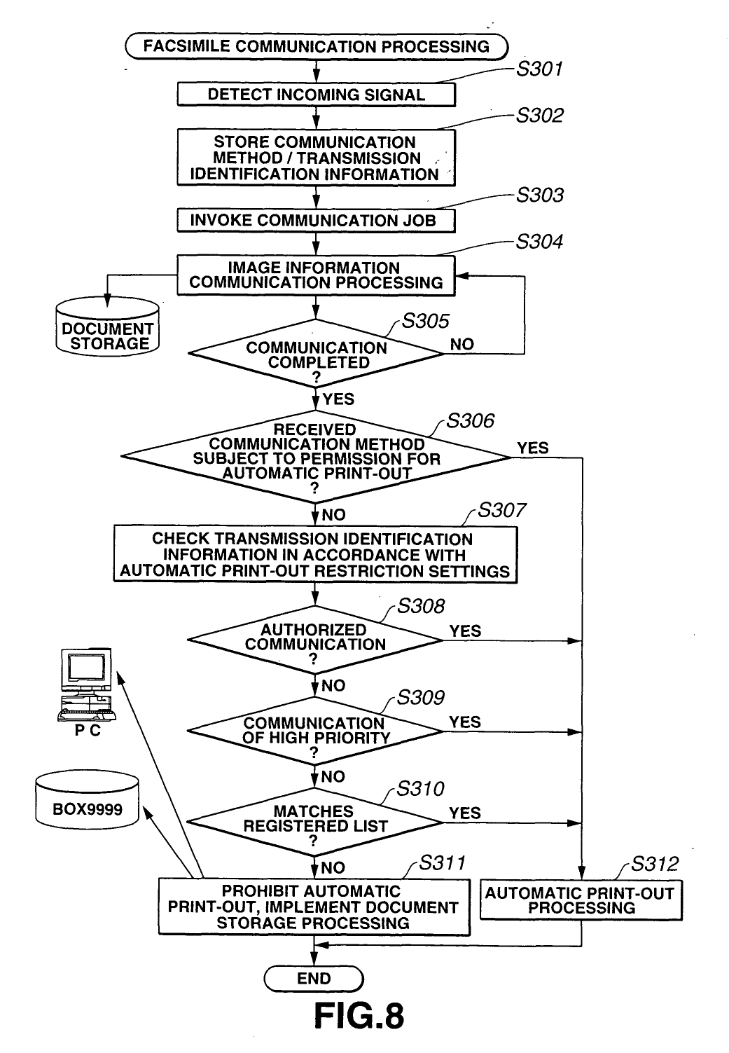

(3) Next, a procedure of processing operations is described in reference to FIG. 8, with respect to a case where processing operations wherein automatic print-out of received documents is restricted according to plural different communication methods as illustrated in FIG. 2, are combined with processing operations wherein the contents of transmission identification information reported by the sender in the case of Internet Fax communications as illustrated in FIG. 4 is checked, and automatic print-out of a document received by the Internet Fax communication in question is restricted according to whether or not the transmission identification information contains information which matches prescribed condition information established previously.

In FIG. 8, if the Internet communication control unit 111, or the existing G3 FAX communication control unit 112, or G4, FAX communication control unit 113 detects an incoming signal on the basis of the control performed by the system control unit 107 (step S301), then firstly, communication method information and transmission identification information for the communication detected in the incoming signal is stored in the RAM 108 (step 302).

Thereupon, a communication job is invoked (step S303), and image information communication processing corresponding to respective communication methods is performed (step S304). In this process, the received document is stored in the image storing unit 106.

When the aforementioned image information communication processing has completed (YES at step S305), it is then determined whether or not the communication method of the communication in question is one for which permission for automatic printout has been set (by referencing the information set via the setting screen shown in FIG. 3 described above) (step S306).

Here, if the communication method of the communication in question is set to permit automatic print-out (YES at step S306), then automatic print processing is implemented for the document received in this communication (step S312), and the composite device 100 transfers to a standby state.

On the other hand, if, as a result of the judgement in step S306 described above, the permission for automatic print-out has not been set with respect to the communication method of the communication in question (NO at step S306), then the transmission identification information is subsequently checked in accordance with the automatic printout restriction settings (by referencing the information set via the settings screen in FIG. 6 described above and by referencing the information registered in the check list illustrated in FIG. 7 described above) (step S307).

If, as a result of this check, it is judged that the document received in the communication in question is not subject to permission for automatic print-out, (if it is not an authorized communication (NO at step S308), nor a communication of high priority (NO at step S309), and neither does it match information registered in a list (NO at step S310)), then automatic printing of the received document is prohibited and processing for storing the document is implemented (step S311).

On the other hand, if, as a result of the check in step S307 described above, it is judged that the document received in the communication in question is subject to permission for automatic print-out, (if it is an authorized communication (YES at step S308), or a communication of high priority (YES at step S309), or it matches information registered in a list (YES at step S310)), then automatic printing of the received document in question is carried out (step S312). In the example in FIG. 6 described above, if the communication is checked for authorization and it is an authorized communication, or if it is checked for high priority and it is a communication of high priority, or if the organization/domain name is checked and it is a communication for which automatic printing has been stipulated, then automatic printing is carried out.

In other words, by means of this processing flow, automatic printing of received documents is restricted separately for plural communication methods (G3/G4 facsimile communications, Store & Forward type communications conforming to ITU-T Recommendation T-37 procedures, Real type communications conforming to ITU-T Recommendation T-38 procedures), in addition to which automatic printing can be restricted on the basis of detailed conditions.

Specifically, even in cases where a setting to prevent automatic print-out is established on the setting screen 102-1 in FIG. 3 above, it is also possible to check the transmission identification information sent by the transmitting device and to restrict automatic print-out of received documents on the basis of information established previously by the user.

Thereby, for example, even if Store & Forward type FoIP communications according to the T.37 procedure are essentially set so that automatic printing thereof is not carried out, in accordance with the settings on the setting screen 102-1 in FIG. 3, automatic print-out is still implemented if the conditions previously established by the user are satisfied when the procedure transfers to the processing from step S306 NO onwards, as described above.

In the processing flow in FIG. 4 and FIG. 6 described above, automatic printing is implemented if the communication is either an authorized communication, or a high priority communication, or matches the information registered in the list, but the invention is not limited to this, and it is also possible to perform automatic printing in a case where the all of the aforementioned conditions are satisfied.

Furthermore, with respect to matching or non-matching with the information registered in the lists, it is also possible to restrict automatic print-out in the case of a match with any one of the registered information elements, and it is also possible to restrict automatic print-out in the case of a match with all of the registered information.

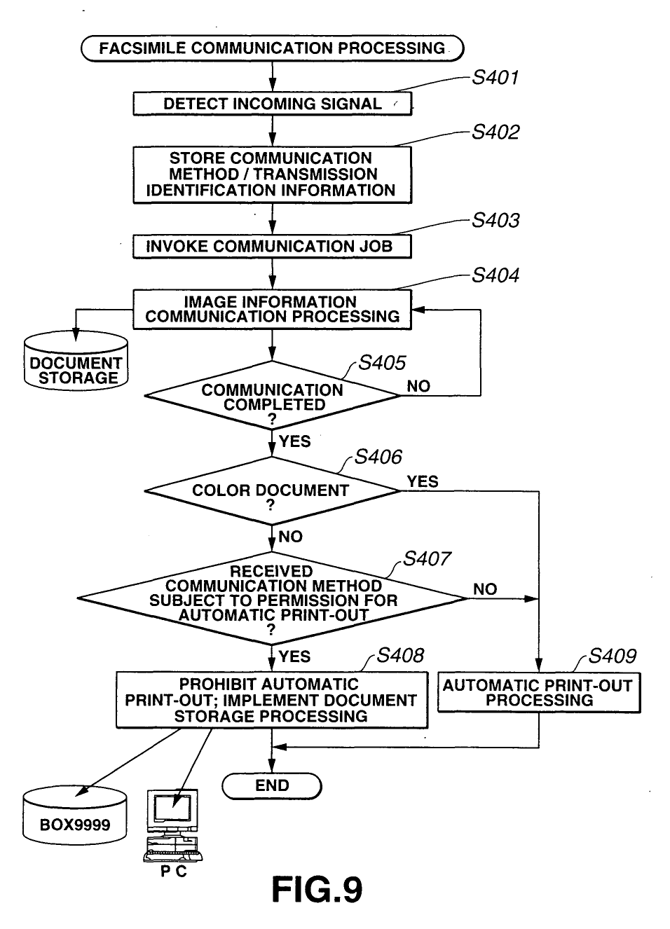

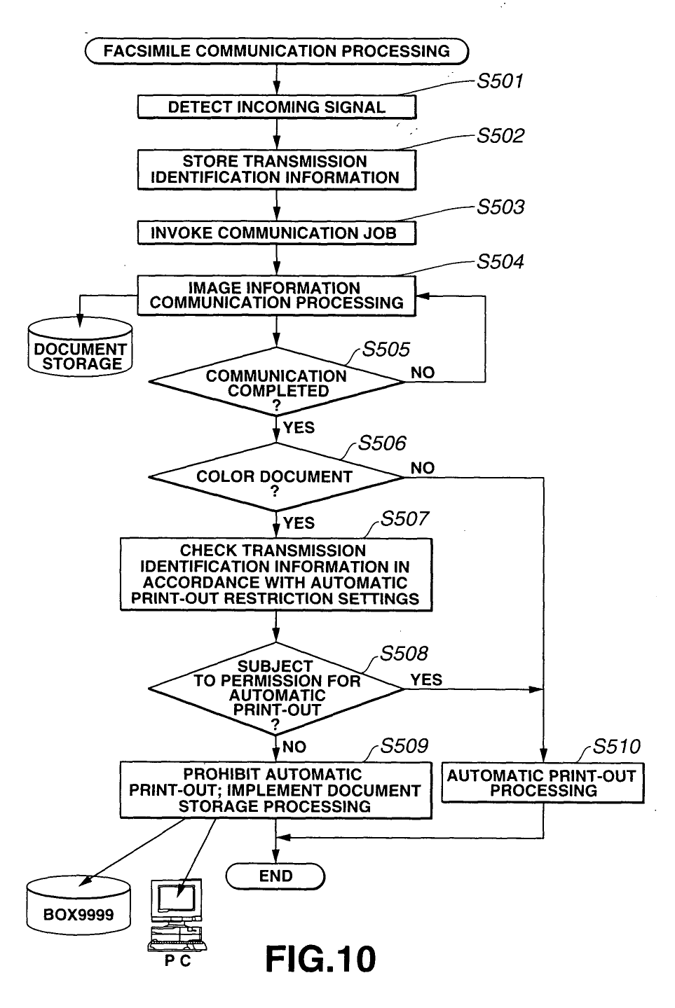

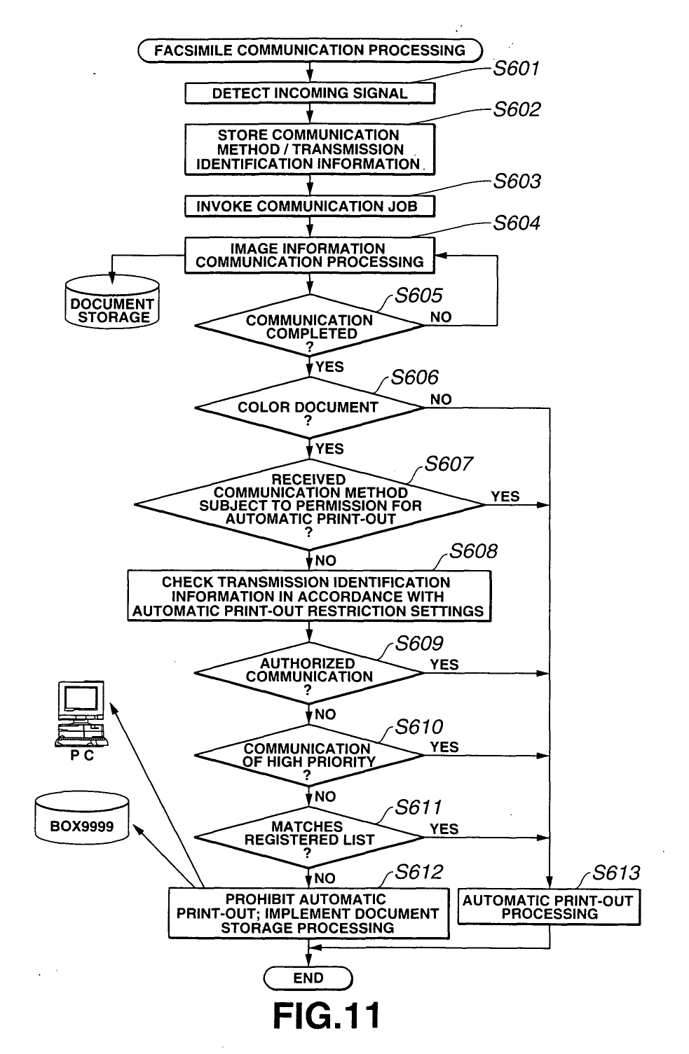

(4) A modification of the processing procedures illustrated in FIG. 2, FIG. 4 and FIG. 8 described above is now described. Specifically, a case where automatic print-out is restricted for received color documents, which have high running costs, is described with reference to FIG. 9, FIG. 10 and FIG. 11.

FIG. 9 shows a modification of the processing procedure shown in FIG. 2 described above.

In FIG. 9, in this case, the point of difference with respect to the processing flow in FIG. 2 is that a judgement process (step S406) for determining whether or not the document received in the communication in question is a color document is added between the processing in step S105 and the processing in step S106, and if the document is not a color document (NO at step S406), then automatic print-out is implemented (step S409), whereas if the document is a color document (YES at step S406), then the processing in the aforementioned step S106 to step S108 (in other words, processing corresponding to that in step S406 to step S409) is implemented. The remainder of the operations are similar to the processing described in FIG. 2 above, and hence description thereof is omitted here.

FIG. 10 shows a modification of the processing procedure shown in FIG. 4 described above.

In FIG. 10, in this case, the point of difference with respect to the processing flow in FIG. 4 is that ajudgement process (step S506) for determining whether or not the document received in the communication in question is a color document is added between the processing in step S205 and the processing in step S206, and if the document is not a color document (NO at step S506), then automatic print-out is implemented (step S510), whereas if the document is a color document (YES at step S506), then the processing in the aforementioned step S406 to step S409 (in other words, processing corresponding to that in step S507 to step S510) is implemented. The remainder of the operations are similar to the processing described in FIG. 4 above, and hence description thereof is omitted here.

FIG. 11 shows a modification example of the processing procedure shown in FIG. 8 described above.

In FIG. 11, in this case, the point of difference with respect to the processing flow in FIG. 8 is that a judgement process (step S606) for determining whether or not the document received in the communication in question is a color document is added between the processing in step S305 and the processing in step S306, and if the document is not a color document (NO at step S606), then automatic print-out is implemented (step S613), whereas if the document is a color document (YES at step S606), then the processing in the aforementioned step S306 to step S312 (in other words, processing corresponding to that in step S607 to step S613) is implemented. The remainder of the operations are similar to the processing described in FIG. 8 above, and hence description thereof is omitted here.

By means of processing of this kind, restriction of automatic print-out can be implemented with respect to color received documents, which involve high running costs, and hence unwanted color output can prevented.

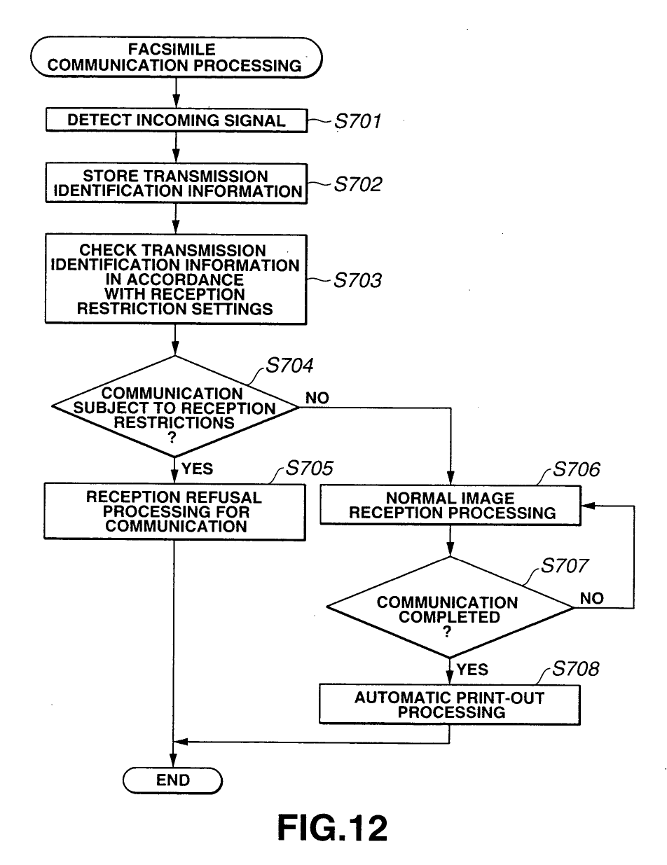

(5) Next, the procedure of processing operations for Internet Fax will be described with reference to FIG. 12, with regard to a case where reception of documents via Internet Fax communications is restricted by checking the contents of the transmission identification information reported by the sender, and determining whether or not this transmission identification information contains information matching prescribed condition information established previously, prior to receiving the document.

In FIG. 12, if the Internet communication control unit 111 detects an incoming signal on the basis of the control implemented by the system control unit 107 (step S701), then firstly, the transmission identification information is stored in the RAM 108 (step S702).

Thereupon, the transmission identification information is checked in accordance with the reception restriction settings (step S703).

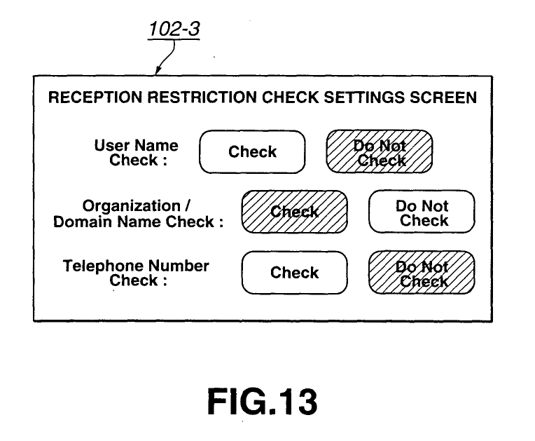

More specifically, the transmission identification information is checked on the basis of the values set by the user via the “Reception restriction check setting screen” 102-3 illustrated in FIG. 13, and it is judged whether or not the received document is one for which the user has permitted reception.

For example, in FIG. 13, if the user has set the User name check option to “check”, then in addition to referencing the From information (the transmitter of the request) contained in the transmission identification information stored in the RAM 108, the registration information (see FIG. 7) in a previously established and stored User name check list is also referenced, and it is decided to receive the document if the user name matches one registered in the check list.

Furthermore, in FIG. 13, if the user has set the organization/domain name check option to “check”, then in addition to referencing the Organization information (name of organization to which device belongs) and the From information (the transmitter of the request) contained in the transmission identification information stored in the RAM 108, the information registered in a previously established and stored organization name/domain name check list (see FIG. 7) is also referenced, and it is decided to receive the document if the organization name/domain name matches one registered in the check list.

Moreover, in FIG. 13, if the user has set the telephone number check option to “check”, then in addition to referencing the p=contact telephone number (telephone number) contained in the transmission identification information stored in the RAM 108, the registration information (see FIG. 7) in a previously established and stored telephone number check list is also referenced, and it is decided to receive the document if the telephone number matches one registered in the check list.

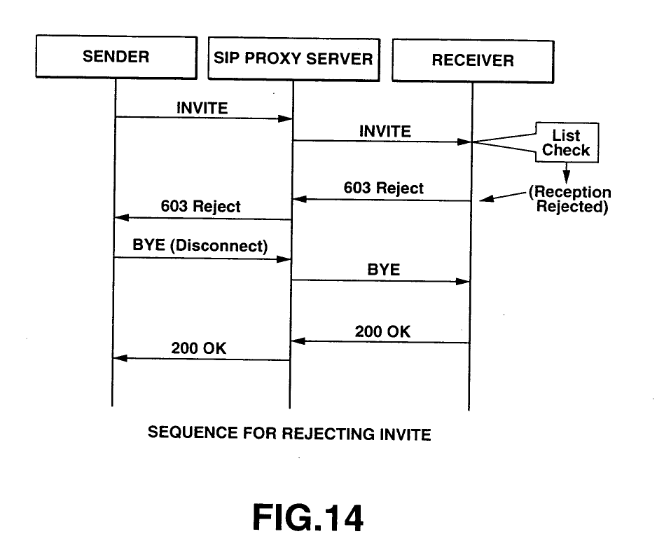

If, as a result of the check performed in step S703 described above, it is determined that the document to be received in the communication in question is one which is set not to be received (YES at step S704), then processing for refusing reception of the document in the communication in question is implemented (step S705). More specifically, a sequence of processing for rejecting the INVITE (connection request) is executed, as illustrated in FIG. 14. More specifically, rejection information of code 603 is reported to the other party, as illustrated in FIG. 14.

Thereupon, the composite device 100 completes facsimile communication processing for the received job.

Furthermore, if, as a result of the check performed in step S703 above, it is determined that the document to be received in the communication in question is not one which has been set not to be received, in other words, if it is eligible for reception processing (NO at step S704), then reception processing for the document in the communication in question is implemented (step S706), and upon completion of the communication (YES at step S707), automatic print-out processing is implemented (step S708). In other words, in the example in FIG. 13 described above, reception is implemented in cases where the communication in question has an organization name/domain name that is registered in the check list.

Thereupon, the composite device 100 completes facsimile communication processing for the received job.

By implementing processing of this kind, in Internet Fax communications, reception of documents via Internet Fax communications can be restricted by checking the contents of the transmission identification information reported by the sender, and determining whether or not this transmission identification information contains information matching prescribed condition information established previously, and hence the actual reception of facsimiles from unapproved parties can be restricted.

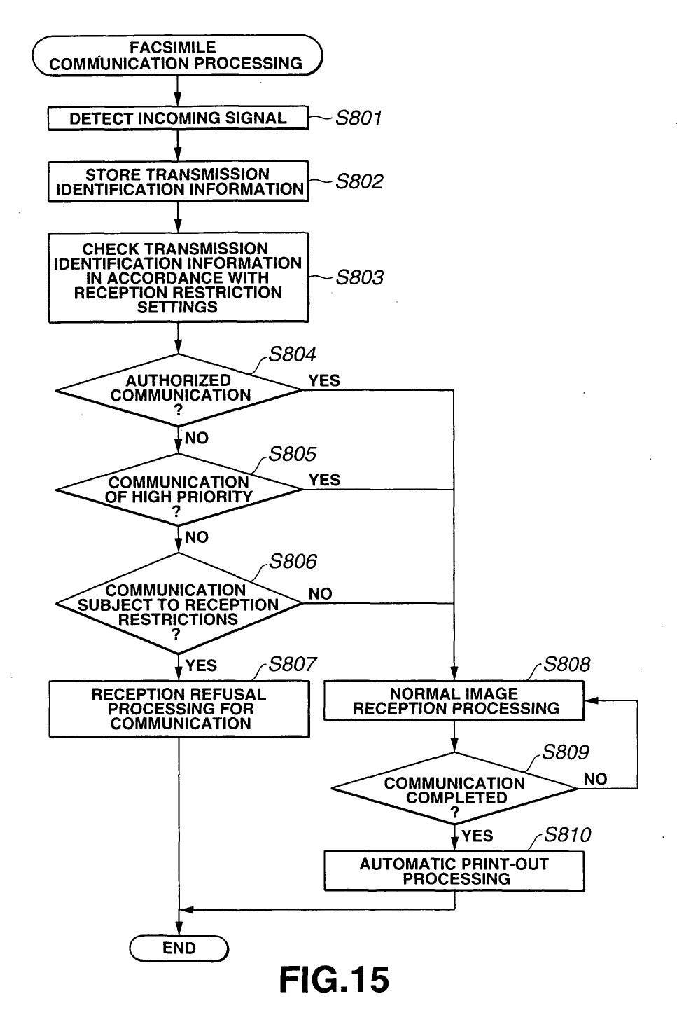

Next, a case is described with reference to FIG. 15 wherein the reception restriction processing illustrated in FIG. 12 is not carried out with respect to received documents which have passed an authorization procedure, or received documents having a high urgency or priority.

In FIG. 15, in this case, the point of difference with respect to the processing flow in FIG. 12 described above, is that judgement processing for determining whether or not the communication in question is an authorized communication (step S804) and judgement processing for determining whether or not the communication in question is a communication of high urgency (step S805) are added in between the processing in step S703 and the processing in step S704, and if the communication is an authorized communication (YES at step S804), or if the communication is a communication of high urgency (YES at step S805), then the processing in aforementioned step S796 to step S708 (which corresponds to the processing in step S808 to step S810) is executed, without performing the reception restriction check in step S704 in FIG. 12 above. The remainder of the operations are similar to the processing described in FIG. 12 above, and hence description thereof is omitted here.

By means of processing of this kind, it is possible to prevent, in advance, any failure to receive documents which have passed an authorization procedure, or documents having a high urgency or priority.

It is also possible to carry out the automatic print-out restriction and control described above (namely, the processing from step S106 onwards in FIG. 2, the processing from step S206 onwards in FIG. 4, the processing from step S306 onwards in FIG. 8, the processing from step S406 onwards in FIG. 9, the processing from step S506 onwards in FIG. 10, and the processing from step S606 onwards in FIG. 11), after step S708 and step S809 described above.

Furthermore, the composite device 100 illustrated in FIG. 1 described above has a composition comprising a G3 FAX communication control unit 112 and a G4 FAX communication control unit 113, but the composition is not limited to this, and in cases where processing relating to Internet facsimile communications as illustrated in FIG. 4 is to be carried out, it is possible for the aforementioned G3 FAX communication control unit 112 and the G4 FAX communication control unit 113 to be omitted.

What is claimed is:

1. An automatic printing restriction and control method for an image processing device which comprises a facsimile communication unit capable of handling plural communication methods including facsimile communications via Internet, and prints out documents received by the facsimile communication unit, comprising:
presetting whether or not automatic printing of received documents is to be implemented, separately with respect to each of the plural communication methods; and
restricting and controlling implementation of automatic printing of received documents in accordance with the settings.

2. The automatic printing restriction and control method according any one of claim 1, wherein it is checked whether or not the received document is a color document, and
implementation of automatic printing of the received document is restricted and controlled in accordance with the settings when the received document is determined to be a color document as a result of the check.

3. An automatic printing restriction and control method for an image processing device which comprises a facsimile communication unit capable of handling plural communication methods including facsimile communications via Internet, and prints out documents received by the facsimile communication unit, comprising:
presetting prescribed condition information for determining whether or not a received document is subject to permission for automatic printing; and
implementing automatic printing of a document received in the communication, when the contents of transmission identification information transmitted by the sender are checked on the basis of the preset prescribed condition information, and it is determined that the document received in the communication is subject to permission for automatic printing.

4. The automatic printing restriction and control method according any one of claim 3, wherein it is checked whether or not the received document is a color document, and
implementation of automatic printing of the received document is restricted and controlled in accordance with the settings when the received document is determined to be a color document as a result of the check.

5. An automatic printing restriction and control method for an image processing device which comprises a facsimile communication unit capable of handling plural communication methods including facsimile communications via Internet, and prints out documents received by the facsimile communication unit, comprising:
setting whether or not automatic printing of received documents is to be implemented, separately with respect to each of the plural communication methods and presetting prescribed condition information for determining whether or not a received document is subject to permission for automatic printing;
restricting implementation of automatic printing of a received document in accordance with the setting indicating whether or not automatic printing of received documents is to be implemented, separately with respect to each of the plural communication methods, and;
implementing automatic printing of a document received in the communication when the contents of transmission identification information transmitted by the sender are checked on the basis of the set prescribed condition information and it is determined that the document received in the communication is subject to permission for automatic printing, even if it has been set not to be printed out automatically by the settings for the communication methods.

6. The automatic printing restriction and control method according any one of claim 5, wherein it is checked whether or not the received document is a color document, and
implementation of automatic printing of the received document is restricted and controlled in accordance with the settings when the received document is determined to be a color document as a result of the check.

7. A document reception control method for an image processing device that comprises a communication unit which performs facsimile communications via Internet, and prints out documents received by the communication unit, comprising:
presetting prescribed condition information for determining whether or not a communication is subject to permission for document reception; and
implementing reception of a document contained in the communication when the contents of the transmission identification information transmitted by the sender are checked on the basis of the established prescribed condition information prior to receiving the document, and the communication is judged to be subject to permission for document reception.

8. The document reception control method according to claim 7, wherein it is judged whether or not the communication has passed an authorization procedure, or whether or not the communication is of high urgency or priority; and
reception of a document is implemented, without determining whether or not the document is subject to permission for document reception, if it is determined as a result of the judgement that the communication has passed an authorization procedure, or that the communication is of high urgency or priority.

9. An image processing device that comprises a facsimile communication unit capable of handling plural communication methods including facsimile communications via Internet, and prints out documents received by the facsimile communication unit, comprising:
a setting unit which sets whether or not automatic printing of received documents is to be implemented, separately with respect to each of the plural communication methods; and
an automatic printing restriction and control unit which restricts and controls execution of automatic printing of received documents in accordance with the settings of the setting unit.

10. The image processing device claim 9, further comprising a checking unit which checks whether or not the received document is a color document, wherein the automatic printing restriction and control unit restricts and controls implementation of automatic printing of a received document in accordance with the settings, when the received document is determined to be a color document as a result of the check performed by the checking unit.

11. The image processing device according to claim 9, wherein the plural communication methods include G3 facsimile communications, G4 facsimile communications, Store & Forward communications conforming to the procedure of ITU-T Recommendation T.37, and Real time communications conforming to the procedure of ITU-T Recommendation T.38; and
the setting unit sets whether or not to implement automatic printing of received documents, separately for the G3 and G4 facsimile communications, the Store & Forward communications conforming to the procedure of ITU-T Recommendation T.37, and the Realtime communications conforming to the procedure of ITU-T Recommendation T.38.

12. An image processing device that comprises a communication unit which performs facsimile communications via Internet, and prints out documents received by the communication unit; comprising:
a setting unit which presets prescribed conditions information for determining whether or not a received document is subject to permission for automatic printing;
a storing unit which stores transmission identification information transmitted by the sender;
a judging unit which checks the contents of the transmission identification information stored in the storing unit on the basis of the prescribed condition information set by the setting unit, and judges whether or not a document received in a communication is subject to permission for automatic printing; and
an automatic printing restriction and control unit which implements automatic printing of a document received in the communication if it is judged by the judging unit to be subject to permission for automatic printing.

13. The image processing device claim 12, further comprising a checking unit which checks whether or not the received document is a color document, wherein the automatic printing restriction and control unit restricts and controls implementation of automatic printing of a received document in accordance with the settings, when the received document is determined to be a color document as a result of the check performed by the checking unit.

14. The image processing device according to claim 12, wherein the prescribed condition information is instruction information instructing that a document received in a communication having passed an authorization procedure is to be permitted for automatic printing; and
the determining unit checks authorization information contained in the stored transmission identification information on the basis of the instruction information and determines that the document received in the communication is subject to permission for automatic printing, if the communication is one having passing an authorization procedure.

15. The image processing device according to claim 12, wherein the prescribed condition information is instruction information instructing that a document received in a communication of high urgency or importance is to be permitted for automatic printing is permitted for; and
the determining unit checks priority information contained in the stored transmission identification information on the basis of the instruction information and determines that the document received in the communication is subject to permission for automatic printing, if the communication is of high urgency or importance.

16. The image processing device according to claim 12, wherein the prescribed condition information is instruction information instructing that a document received in a communication having a previously specified user name is to be permitted for automatic printing; and
the determining unit checks user name information contained in the stored transmission identification information on the basis of the instruction information and determines that the received document is subject to permission for automatic printing, if the communication is one having a previously specified user name.

17. The image processing device according to claim 12, wherein the prescribed condition information is instruction information instructing that a document received in a communication having a previously specified organization name or domain name is to be permitted for automatic printing; and
the determining unit checks organization name or domain name information contained in the stored transmission identification information on the basis of the instruction information and determines that the received document is subject to permission for automatic printing, if the communication is one having a previously specified organization name or domain name.

18. The image processing device according to claim 12, wherein the prescribed condition information is instruction information instructing that a document received in a communication having a previously specified telephone number is to be permitted for automatic printing; and
the determining unit checks telephone number information contained in the stored transmission identification information on the basis of the instruction information and determines that the received document is subject to permission for automatic printing, if the communication is one having a previously specified telephone number.

19. The image processing device according to claim 12, wherein the prescribed condition information is instruction information instructing that a document received in a communication having a previously specified user name is to be refused of automatic printing; and
the determining unit checks user name information contained in the stored transmission identification information on the basis of the instruction information and determines that the received document is subject to refusal of automatic printing, if the communication is one having a previously specified user name.

20. The image processing device according to claim 12, wherein the prescribed condition information is instruction information instructing that a document received in a communication having a previously specified organization name or domain name is to be refused o automatic printing; and
the determining unit checks organization name or domain name information contained in the stored transmission identification information on the basis of the instruction information and determines that the received document is subject to refusal of automatic printing, if the communication is one having a previously specified organization name or domain name.

21. The image processing device according to claim 12, wherein the prescribed condition information is instruction information instructing that a document received in a communication having a previously specified telephone number is to be refused of automatic printing; and
the determining unit checks telephone number information contained in the stored transmission identification information on the basis of the instruction information and determines that the received document is subject to refusal of automatic printing, if the communication is one having a previously specified telephone number.

22. An image processing device that comprises a communication unit which performs facsimile communications via Internet, and prints out documents received by the communication unit, comprising:
a setting unit which presets prescribed condition information for determining whether or not a communication is subject to permission for document reception;
a storing unit which stores transmission identification information transmitted by the sender, prior to receiving a document;
a judging unit which checks the contents of the transmission identification information stored in the storing unit on the basis of the prescribed condition information set by the setting unit, and judges whether or not the communication is one which is subject to permission for document reception; and
a document reception control unit which implements reception of a document in the communication if the judging unit judges that the communication is subject to permission for document reception.

23. The image processing device according to claim 22, wherein the prescribed condition information is instruction information instructing that a document received in a communication having a previously specified user name is to be permitted for reception; and
the determining unit checks user name information contained in the stored transmission identification information on the basis of the instruction information and determines that a document in the communication is subject to permission for reception, if the communication is one having a previously specified user name.

24. The image processing device according to claim 22, wherein the prescribed condition information is instruction information instructing that a document received in a communication having a previously specified organization name or domain name is to be permitted for reception; and
the determining unit checks organization name or domain name information contained in the stored transmission identification information on the basis of the instruction information and determines that a document in the communication is subject to permission for reception, if the communication is one having a previously specified organization name or domain name.

25. The image processing device according to claim 22, wherein the prescribed condition information is instruction information instructing that a document received in a communication having a previously specified telephone number is to be permitted for reception; and
the determining unit checks telephone number information contained in the stored transmission identification information on the basis of the instruction information and determines that a document in the communication is subject to permission for reception, if the communication is one having a previously specified telephone number.

26. The image processing device according to claim 22, wherein the prescribed condition information is instruction information instructing that a document received in a communication having a previously specified user name is to be refused of reception; and
the determining unit checks user name information contained in the stored transmission identification information on the basis of the instruction information and determines that a document in the communication is subject to refusal of reception, if the communication is one having a previously specified user name.

27. The image processing device according to claim 22, wherein the prescribed condition information is instruction information instructing that a document received in a communication having a previously specified organization name or domain name is to be refused of reception; and
the determining unit checks organization name or domain name information contained in the stored transmission identification information on the basis of the instruction information and determines that a document in the communication is subject to refusal of reception, if the communication is one having a previously specified organization name or domain name.

28. The image processing device according to claim 22, wherein the prescribed condition information is instruction information instructing that a document received in a communication having a previously specified telephone number is to be refused of reception; and
the determining unit checks telephone number information contained in the stored transmission identification information on the basis of the instruction information and determines that a document in the communication is subject to refusal of reception, if the communication is one having a previously specified telephone number.

29. The image processing device according to claim 22, further comprising a judging unit which judges whether the communication has passed an authorization procedure, or whether it is a communication of high urgency or priority;
wherein the judgement process of the judging unit and control of document reception by the document reception control unit is prohibited and document reception is implemented, if it is determined as a result of the judgement by the judging unit that the communication has passed an authorization procedure, or is of high urgency or priority.
